(19) United States
(12) Patent Application Publication
(10) Pub. No.: US 2004/0035854 A1
(43) Pub. Date: Feb. 26, 2004

(54) Electric heating wire and applications thereof

(76) Inventors: Chung-Chi Cheng, Taichung (TW); Wen-Chang Shin, Beituen Chiu (TW); Maxwell Hsu, Jungli City (TW)

Correspondence Address: BIRCH STEWART KOLASCH & BIRCH, PO BOX 747, FALLS CHURCH, VA, 22040-0747, US

(21) Appl. No.: 10/225,234

(22) Filed: Aug. 22, 2002

(51) Int. Cl. H05B 3/56

(52) U.S. Cl. 219/549; 219/529; 219/212

(57) ABSTRACT

An electric heating wire and applications thereof with the electric wire consists of a core made from a plurality strands of graphite fibers. The core is wound by an oblate insulation layer which has two wing flaps on the left and right sides for stitching and anchoring use. The core of the electric wire that consists of graphite fiber can generate heat when energized. The electric wire thus made may be anchored on blankets quickly to form an electric blanket, and can prevent rupture resulting from fatigue caused by temperature variations. The electric wire and the electric blanket thus formed have improved safety when in use and have a greater durability.

### FIELD OF THE INVENTION

The present invention relates to an electric heating wire and its applications, and particularly an electric heating wire that does not incur fatigue due to temperature difference during heating and has a high tensile strength and pressure resistance to prevent rupture, and is applicable for electric blankets and thermal pads with desired safety, durability, and ease of fabrication.

### BACKGROUND OF THE INVENTION

A conventional electric heating wire as shown in FIG. 1 mainly includes a core 1 made from glass fiber, a copper nickel wire (or a copper chrome wire) 2 wound around the glass fiber in helical manner, a nylon layer 3 shrouding the wound glass fiber, a thermal sensitive nickel wire 4 wound around the nylon layer 3, and finally a plastic insulation layer 5 cover to form the outmost skin. The copper nickel wire (or copper chrome wire) 2 has two ends to plug to an electric power supply to generate heat and become the electric heating wire. When the copper nickel wire (or copper chrome wire) 2 receives electricity, its temperature rises. As the copper nickel wire (or copper chrome wire) 2 is made in a fine conductive wire, it extends at the high temperature, and its tensile strength decreases. When the temperature drops, the wire returns to its original condition. The repetitive temperature variations tend to incur fatigue on the copper nickel wire (or copper chrome wire) 2 and result in rupture of the wire. This is one of the common causes of the malfunction of the electric heating wire. The wire also is easy to break apart under a strong pulling force or when being folded and pressed.

Moreover, conventional electric heating wires are made in a round shape, and are difficult to be fixed inside the electric blanket. The blanket tends to form a lump when in use. The blanket embedded with round wires also generates a stiff touch which is not comfortable to people cuddled in the blanket.

### SUMMARY OF THE INVENTION

Therefore the primary object of the invention is to provide an electric heating wire that has a core wound by an oblate insulation layer with two wing flaps for stitching to the felt in the electric blanket or thermal pad to anchor the electric heating wire quickly.

Another object of the invention is to provide an electric heating wire that adopts a design to prevent fatigue caused by temperature variations when heated and rupture caused by decreasing of tensile strength and pressure resistance, thereby to achieve improved safety and durability.

Yet another object of the invention is to provide an electric blanket that employs the heating wire which has a graphite fiber core to conduct heat and raise temperature rapidly to save electricity.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional electric heating wire.

FIG. 2 is a perspective view of the electric heating wire of the invention.

FIG. 3 is a cross section according to FIG. 2.

FIG. 4 is a perspective view of another embodiment of the electric heating wire of the invention.

FIG. 5 is a pictorial view of the electric heating wire of the invention adopted on an electric blanket.

FIG. 6 is a schematic front view according to FIG. 5.

FIG. 7A is a schematic perspective view of the electric heating wire of the invention adopted on a thermal pad.

FIG. 7B is a cross section taken along line 7B-7B in FIG. 7A.

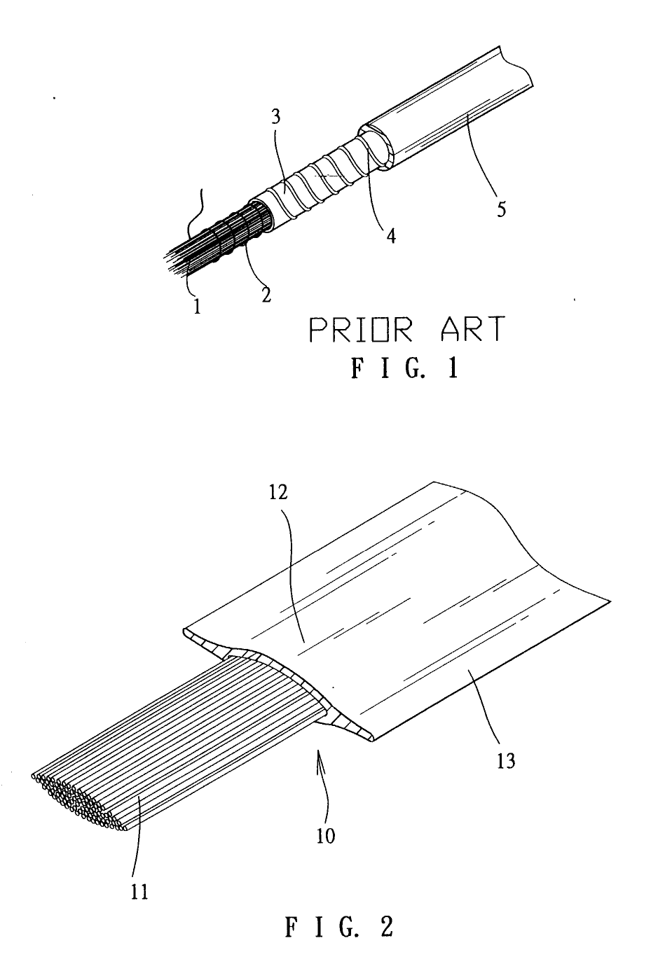

### DESCRIPTION OF THE PREFERRED EMBODIMENTS

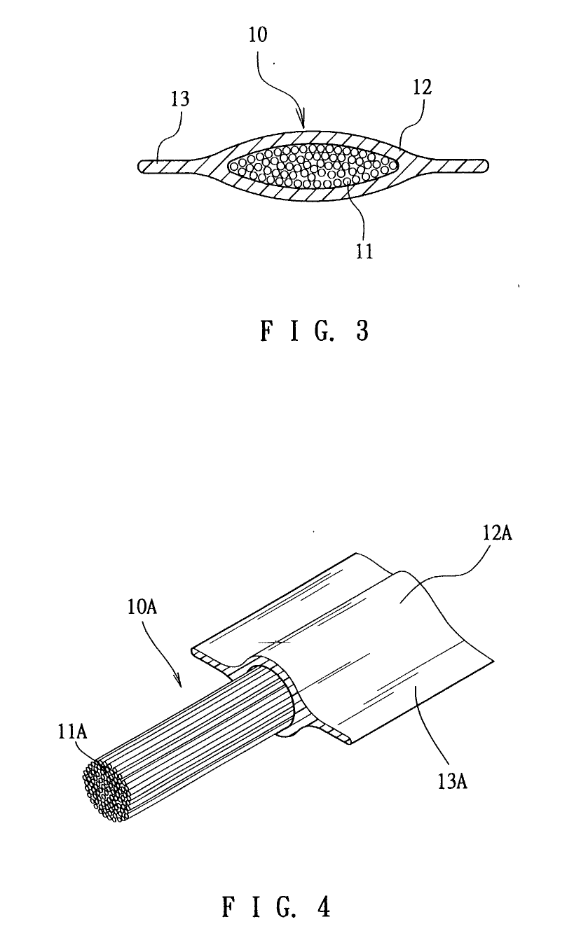

Referring to FIGS. 2 and 3, the electric heating wire 10 of the invention includes a non-metal core 11 which consists of a plurality of strands of graphite fibers. The core 11 is wound axially in an even thickness by an oblate insulation layer 12 made from thermoplastic polyurethane (TPU). The insulation layer has two wing flaps 13 on the left and right sides for stitching use.

Referring to FIG. 4, the electric heating wire 10A of the invention may also be made in a circular bundle wound by an insulation layer 12A with two wing flaps 13A formed on two sides. Such a construction may be used on products that do not demand a high degree of pliability.

By means of the construction set forth above, when the core wire 11 made from the graphite fibers is energized by electricity, it generates heat. As the graphite fiber is formed by graphitization of carbon in inert gas at high temperature, it has an evenly aligned crystal structure and a stable resistance. When heated or cooled, it does not incur much extension or retraction because of temperature variations. Thus it can effectively prevent fatigue and rupture. As a result, it provides greater safety and durability. In addition, the core 11 made from graphite fibers conducts heat and attain a high temperature rapidly, thus it also can save electricity.

Furthermore, the core 11 in the electric heating wire 10 of the invention is formed by combining a plurality strands of graphite fibers. The core 11 does not extend when the temperature of the electric heating wire rises, and does not incur fatigue when the temperature drops, and also offers desired pressure resistance and tensile strength. Thus it effectively overcomes the disadvantages of conventional electric heating wires made from copper nickel wires (or a copper chrome wires) 2 wound around the glass fiber 1 in a helical manner, such as incurring fatigue at difference temperatures, different density of the helical coil structure of the copper nickel wires (or a copper chrome wires) 2 and the uneven heating of the entire electric heating wire that ensues.

In addition, the wing flaps 13 extended from the left and right sides of the insulation layer 12 of the electric heating wire 10 can facilitate stitching operation of the electric heating wire 10 to the pliable felt of the blanket and speed up fabrication. The insulation layer 12 made from TPU is tough and has a great resistance to scrape. Therefore the electric wire 10 thus made can resist deformation and high temperature, and has great insulation and durability.

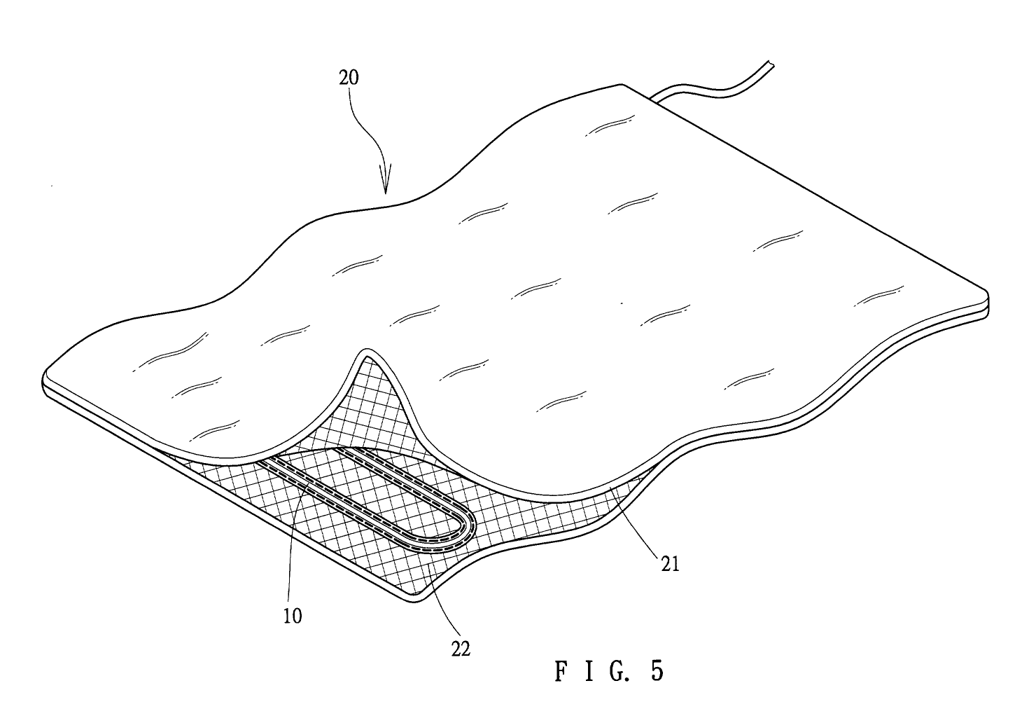

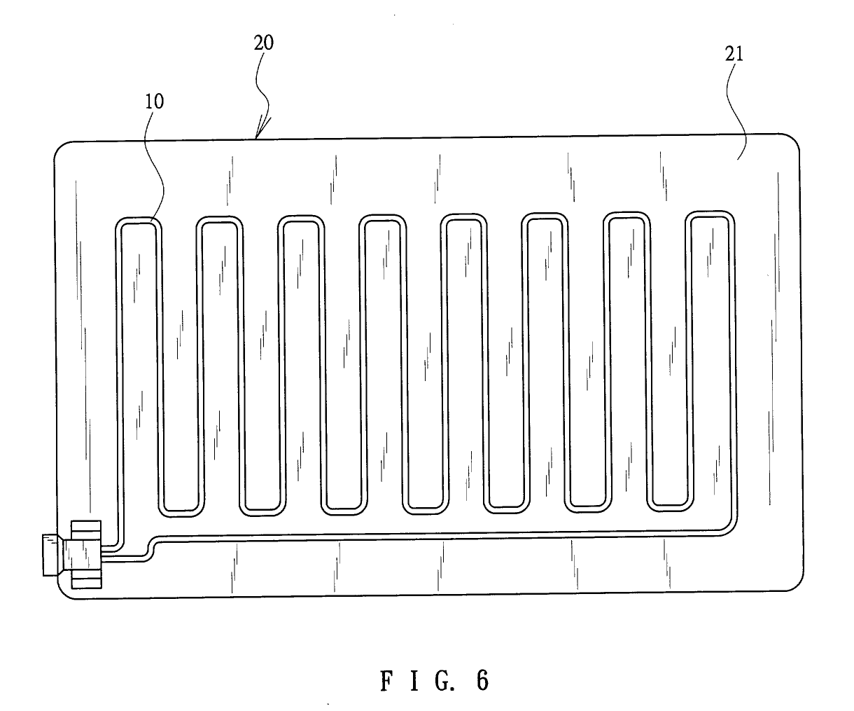

Refer to FIGS. 5 and 6 for a first application of the invention adopted on an electric blanket 20. The electric blanket 20 has an upper layer and a lower layer made from a non-woven fabric 21. The two inner sides of the non-woven fabric 21 are bonded respectively to a layer of reinforced yarn 22 to increase the tensile strength and toughness. An electric heating wire 10 formed in S-shape is disposed between the two layers of the reinforced yarn 22. One layer of the reinforced yarn 22 is stitched to the upper side of the non-woven fabric 21. Then cover the other layer of the non-woven fabric 21 that already has the reinforced yarn 22 stitched thereon over the electric heating wire 10 to formed an integrated electric blanket 20. As the filaments of the non-woven fabric is more fluffy than ordinary fabrics, the finished blanket 20 supported by the meshed reinforced yarn 22 provides a soft and comfortable touch sense.

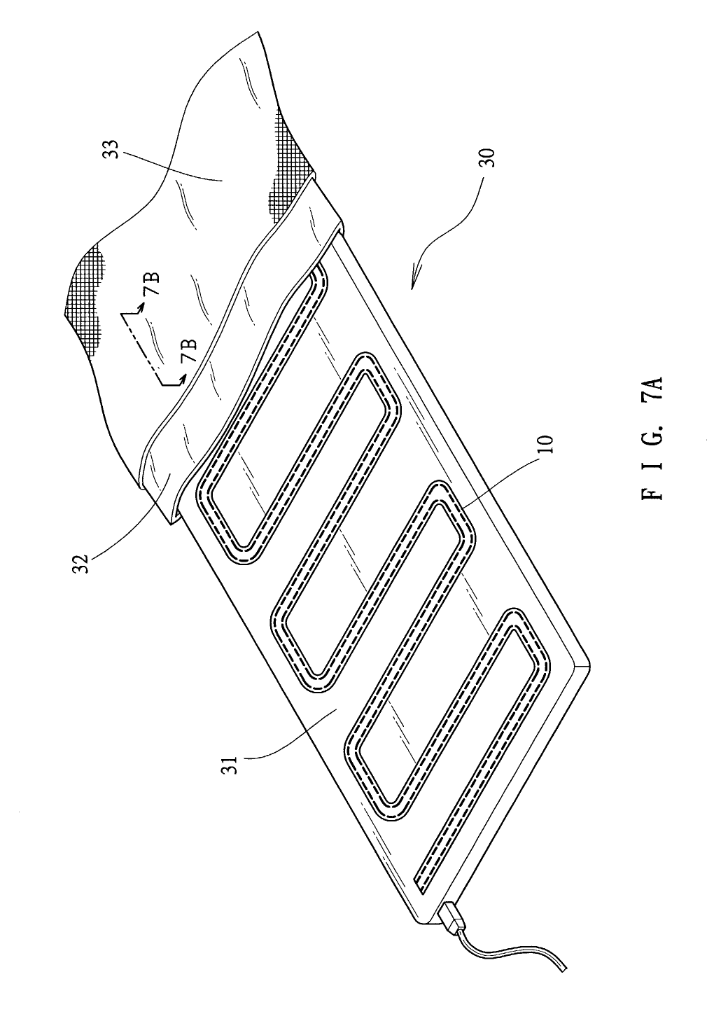

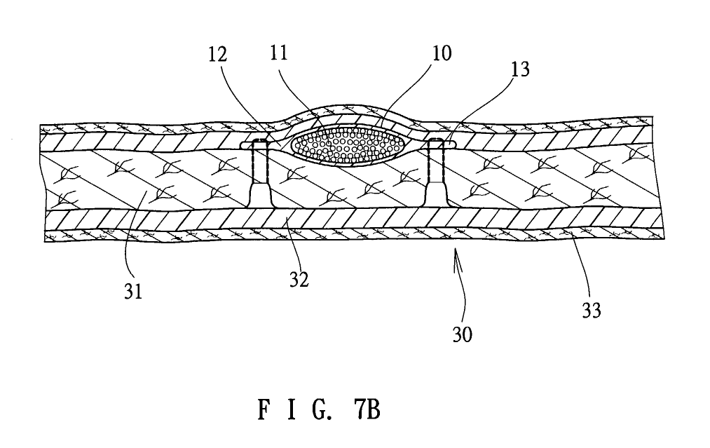

Refer to FIGS. 7A and 7B for a second application of the electric heating wire 10 of the invention. The electric wire 10 may be stitched on a woolen blanket 31 in S-shape patterns in a zigzag fashion. Such a structure can facilitate fabrication and offer a desired bonding force. Finally, the blanket 31 with the electric heating wire 10 stitched thereon is housed in a heat insulation cover 32 which is further wrapped by a water molecular thermal pad 33 to form a completed heating pad 30.

As the core 11 of the electric heating wire 10 is made from non-metal graphite fibers and has a great pliability, it has great pressure resistance and tensile strength. Even if the electric blanket 20 is laid on the spring mattress with users standing or kneeing thereon, the electric heating wire still can withstand the pressure without breaking. Moreover, the insulation layer 12 covered the core 11 is made from TPU which has a great toughness and is heat resistant, and can give the electric heating wire 10 greater durability and safety. In addition, the oblate structure and pliability give users more comfortable feeling. As the graphite fibers conduct heat very quickly, electricity consumption is reduced. It also effectively resolves the uneven heating problem resulting from helical wiring of the copper nickel wires (or a copper chrome wires) 2 occurs to conventional electric heating wires.

What is claimed is:

1. An electric heating wire, comprising:
a core consisting of a plurality of strands of graphite fibers; and
at least one insulation layer wound around the core with the outmost layer thereof having two sides forming wing flaps for stitching to and anchoring on a blanket.

2. The electric heating wire of claim 1, wherein the insulation layer is made from thermoplastic polyurethane (TPU).

3. An electric heating wire adopted for use on an electric blanket, comprising:
at least one electric heating wire located in the blanket in a zigzag fashion having a core consisting of a plurality of strands of non-metal graphite fibers, the core being wound by at least one insulation layer with the outmost layer thereof having two sides forming wing flaps for stitching and anchoring use.
